(19) United States
(12) Patent Application Publication
(10) Pub. No.: US 2009/0105857 A1
(43) Pub. Date: Apr. 23, 2009

(54) METHOD OF AUTOMATIC PLAYLIST CREATION ON MULTIMEDIA PLAYER

(75) Inventors: Chien-Ming Huang, Jung-He City (TW); Chien-Chih Liao, Jung-He City (TW); Chi-Hsien Chen, Jung-He City (TW)

Correspondence Address: STEVENS & SHOWALTER LLP, 7019 CORPORATE WAY, DAYTON, OH, 45459-4238, US

(73) Assignee: MICRO-STAR INTERNATIONAL CO., LTD., Jung-He City (TW)

(21) Appl. No.: 12/211,926

(22) Filed: Sep. 17, 2008

(30) Foreign Application Priority Data
Oct. 17, 2007 (TW) 096138906

(51) Int. Cl. G06F 17/00

(52) U.S. Cl. 700/94

(57) ABSTRACT

A multimedia player capable of automatically creating a play list and a method thereof are described. The play lists corresponding to a variety of time segments are created according to time segments in a time period. The multimedia player creates a play list for a certain time segment according to a number of times that songs are completely played and a playback mode of the songs. When the multimedia player works in a same time segment in another time period, the multimedia player loads the play list of the previous time segment, and applies the playback mode previously set for each of the songs to the corresponding song.

### CROSS-REFERENCE TO RELATED APPLICATIONS

This non-provisional application claims priority under 35 U.S.C. § 119(a) on Patent Application No(s). 096138906 filed in Taiwan, R.O.C. on Oct. 17, 2007 the entire contents of which are hereby incorporated by reference.

### BACKGROUND OF THE INVENTION

1. Field of Invention

The present invention relates to a multimedia player capable of automatically creating a play list and a method thereof. More particularly, the present invention relates to a multimedia player capable of automatically creating a play list according to a playback mode and attributes of a song in different time segments.

2. Related Art

In addition to normal playback modes, a common multimedia player available in market also provides a user-defined play list function, which allows a user to edit favorite songs (maybe coming from different albums or of different singers) into one play list. Thus, the user can listen to the songs conveniently without switching between different albums. For example, iPod multimedia player series manufactured by Apple Computer allow the user to record the songs in the iPod into play lists. Then, the user can listen to the songs coming from different albums or singers sequentially only by loading these play lists. However, the play lists must be set manually by the user.

Currently, the memory capacity of many multimedia players is calculated on a gigabyte basis. For example, if the size of a song in MP3 format is 5 Mb, a 30 G multimedia player can store 6144 songs. As the number of the songs is very large, it is difficult for the user to choose a desired song from the songs. In addition, it is also a problem to edit the play list for so many songs.

### SUMMARY OF THE INVENTION

Accordingly, the present invention is directed to a method of automatically creating a play list, so as to set the play lists of a multimedia player.

In order to achieve the above objective, the method of automatic play list creation is described as follows.

A play list is created, and a number of times of each of the songs that is completely played in a time segment of a time period are counted, and then names of the songs are written into a play list of a time segment, such that a multimedia player loads the play list and plays the songs in the play list in a same time segment of another time period. Playback modes of the songs are recorded, and the playback modes set for the songs in the play list during playback are recorded. The play lists corresponding to the time segments are stored.

In another aspect of the present invention, the present invention provides a multimedia player capable of automatically creating a play list. The multimedia player stores a plurality of play lists. The multimedia player loads the previously created play lists in different time segments. If a time segment does not have a corresponding play list, the multimedia player automatically creates a play list according to a playback mode of songs.

In order to achieve the above objective, the multimedia player capable of automatically creating a play list of the present invention includes a playback module, a plurality of function buttons, a storage unit, a database module, and a selecting means.

The playback module decodes songs to play, and provides a playback function of the songs. The plurality of function buttons are electrically connected to the playback module for operating the multimedia player. The storage unit is electrically connected to the playback module, and is used to store a plurality of songs. The database module stores play lists. The selecting means is used to select songs that are completely played for a number of times meeting a threshold value in a time segment, and lists the songs into a play list corresponded to the time segment.

The present invention automatically records the playback modes of the songs in the multimedia player in different time segments of a time period, and creates play lists according to the playback modes of the songs. In next time segment, the multimedia player will preferably select the songs in the play lists.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more completely understood from the detailed description given herein below for illustration only, and thus are not limitative of the present invention, and wherein:

FIG. 1 is a schematic view of an architecture of the present invention;

FIG. 2a is a schematic view of a time period and time segments;

FIG. 2b is a schematic view of creating play lists in a plurality of time periods of the present invention;

FIG. 2c is a schematic view of play lists of different time segments;

FIG. 3a is a flow chart of creating a play list;

FIG. 3b is a flow chart of the multimedia player when playing a play list of the songs;

FIG. 3c is a flow chart of recording the song playing behaviors when playing the songs in the play list; and

FIG. 4 is a flow chart of an operation of selecting substitutive songs.

### DETAILED DESCRIPTION OF THE INVENTION

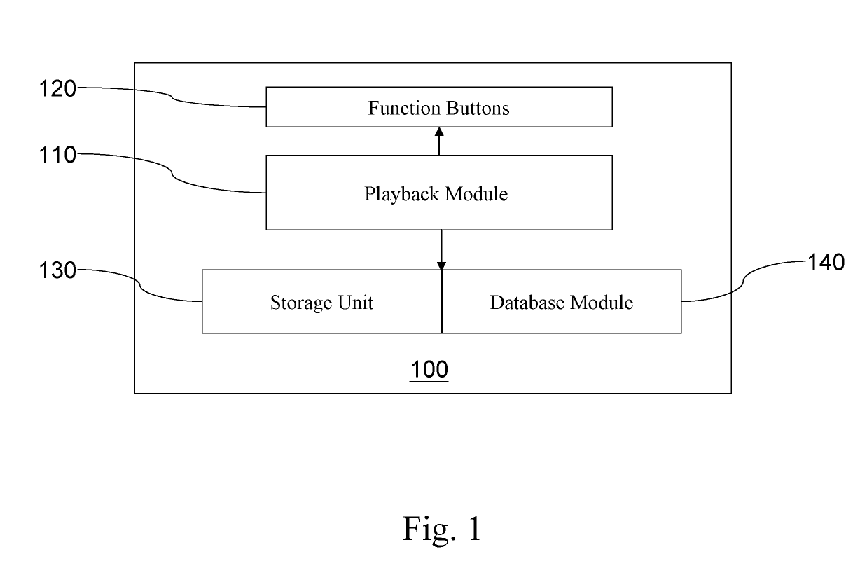

The present invention is a multimedia player, which may be, but is not limited to, a MP3 (MPEG-1 Audio Layer 3) player, a Compact Disc read-only memory (CD-ROM) player, or a MD (MiniDisc) player. FIG. 1 is a schematic view of architecture of the present invention. Referring to FIG. 1, the multimedia player 100 includes a playback module 110, a plurality of function buttons 120, a storage unit 130, a database module 140, and a selecting means.

The playback module 110 decodes songs to play, and provides a playback function of the songs. For example, when a user sends a command of fast forwarding a song, the playback module 110 will calculate and respond with an action of fast forwarding the song. The plurality of function buttons 120 are electrically connected to the playback module 110 for operating the multimedia player. The function buttons 120 of the multimedia player at least include a play button, a volume button, or a previous/next button.

The storage unit 130 is electrically connected to the playback module 110 for storing a plurality of songs. The storage unit 130 may be a hard disk, a flash memory, or an optical disk. The selecting means may be implemented with software or firmware, and is loaded in the playback module 110 to realize its function. The selecting means selects the songs that are completely played for a number of times meeting a threshold value in a time segment, and lists the songs into a play list corresponding to the time segment.

The database module 140 is electrically connected to the playback module 110 for storing the play lists corresponding to each time period. In addition to being placed in the storage unit 130, the database module 140 may also be placed in another independent storage device disposed in the multimedia player.

In the present invention, as for different time segments in a time period, the play list of a time segment is created according to the playing songs in the time segment and the playback modes. The time period may be a year, a quarter of a year, a month, a week, or a day. For example, when the time period is a week, each day may be regarded as a time segment of the week. If the multimedia player creates a new play list on Wednesday this week, then on next Wednesday, the multimedia player will preferably load the play list created on this Wednesday. Similarly, if the time period is a day, the day may be further divided into different time segments such as forenoon, afternoon, evening, night, and morning.

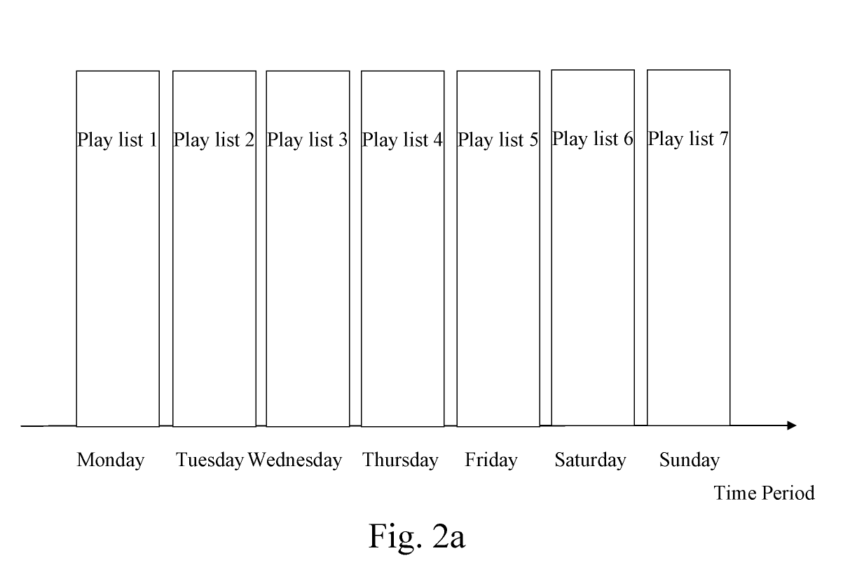

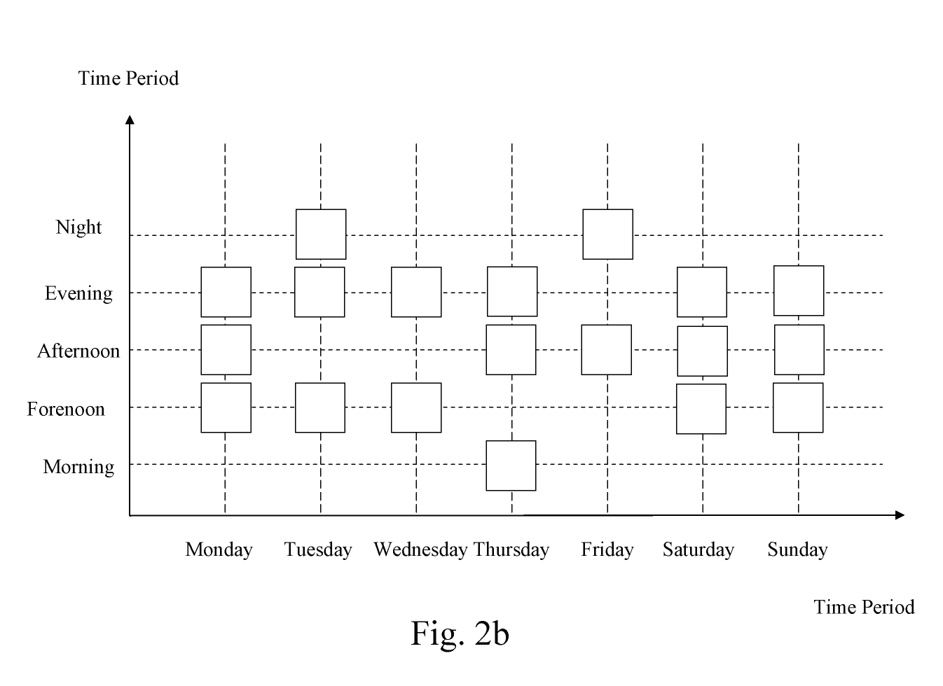

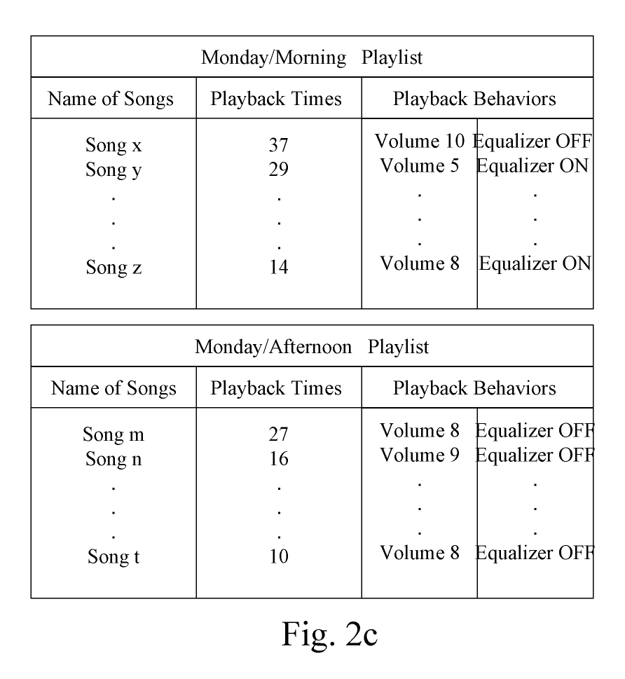

In other words, a time segment is a minimum unit of a time period, and the duration of the time segments are difference. FIG. 2a is a schematic view of a time period and time segments. Referring to FIG. 2a, the time period of a week is used to illustrate this embodiment. In FIG. 2a, the transverse axis is the time period, and one day is a time segment. Taking FIG. 2a for example, each day has a corresponding play list. Thus, in the same time segment of the next week, the play list is loaded into the multimedia player and is played.

Furthermore, in addition to using a week as a time period, the present invention may also use a plurality of time periods at the same time. FIG. 2b is a schematic view of creating play lists in a plurality of time periods of the present invention. Referring to FIG. 2b, in the above example, in addition to setting a week as a time period, each day is also set as another time period at the same time. In this embodiment, a day is further divided into different time segments, such that the play lists corresponding to different time segments of a day are independent from one another, shown as the longitudinal axis of FIG. 2b, and the blocks in FIG. 2b represent the play lists of different time segments. FIG. 2c is a schematic view of play lists of different time segments. Referring to FIG. 2c, the play lists corresponding to the forenoon and afternoon on Monday are shown. The names of the songs to play and the corresponding playback modes of the songs are recorded in the play lists.

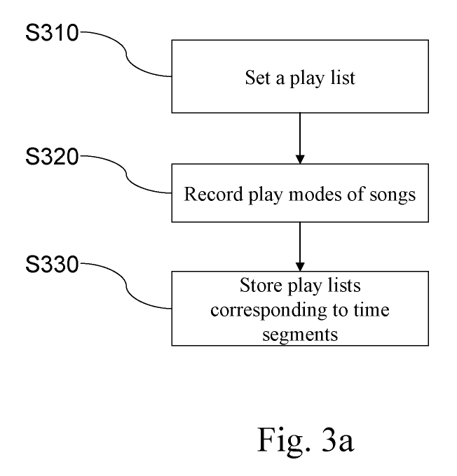

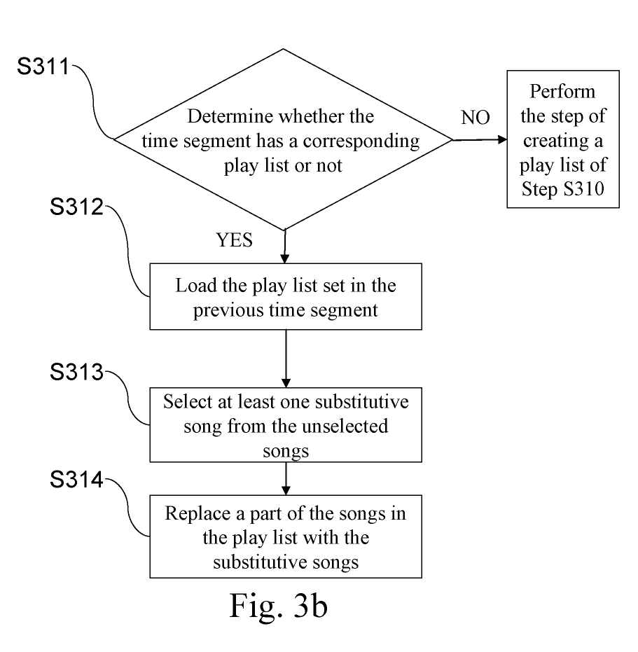

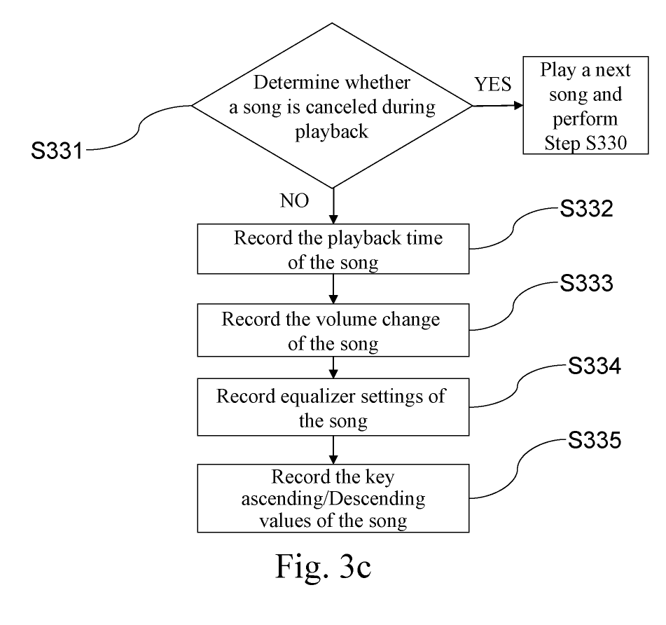

The present invention also provides a method of automatic play list creation on a multimedia player, which is described as follows. Referring to FIG. 3a, a play list is set (step S310), a number of times that each song is completely played in a time segment of a time period are counted, and names of the songs are written into a play list corresponding to a time segment, such that the multimedia player loads the play list in a same time segment of another time period and plays the songs in the play list. Playback modes of the songs are recorded, and the playback modes set for the songs in the play list during playback are recorded (step S320). The play lists corresponding to the time segments are stored (step S330).

The threshold value can be set according to a ranking result of the number of times that songs are completely played. For example, in the current time segment, the songs that have been completely played are ranked in a descending sequence, and the first 10% songs in the song collection are taken as the songs to be recorded in the play list of the time segment. The threshold value may also be determined by manufacturers/users.

Referring to FIG. 3b, the multimedia player plays the songs in a play list in the following steps. Determine whether the time segment has a corresponding play list or not (step S311). If yes, then load the play list set in the previous time segment (step S312). The multimedia player selects at least one substitutive song from among the songs not included in the play list, (step S313). Songs having the same number of the substitutive songs are randomly selected from the play list, and are replaced by the substitutive songs.

For example, if 10 songs in the play list are selected to be replaced, the playback module 110 will randomly select 10 songs from among the songs not included in the play list to replace the 10 songs in the play list. A part of the songs in the play list are replaced by the substitutive songs (step S314). If the time segment does not have a play list, then the step of creating a play list (S310) is performed.

Referring to FIG. 3c, when the multimedia player playing the songs in the play list records the playing songs, which further includes the following steps. Determine if a song is canceled during playback (step S331). If the song is not canceled during playback, then record the playback time of the song (step S332). Record the volume change of the song (step S333). Record an equalizer setting of the song (step 334). Record the key ascending/descending value of the song (step S335). If the song is canceled during playback, then play the next song and repeat step S330. Till this time segment is terminated, the setting of the play list of the time segment is completed.

In order to illustrate the operation flow of the present invention more clearly, the operating process will be described below, in which a multimedia player without any play list is taken as an example, the time period is a week, and Sunday through Monday are different time segments.

If the multimedia player starts to play songs from Monday of the first week, as the multimedia player does not have a play list corresponding to Monday, the multimedia player will record the playback mode of the currently playing song. For example, whether the song is completely played, the volume change during playback, and the equalizer intensity adjustment during playback will be recorded. The multimedia player then ranks the songs according to the number of times that the songs are completely played on Monday, and records the songs in the play list according to the ranking result.

For example, if the multimedia player stores 3000 songs and each play list includes at most 100 songs, the multimedia player will rank the 3000 songs according to the number of times that the songs are completely played, and list the first 100 songs according to the ranking result into the play list of Monday. If the number of songs is less than the allowed number of the play list, other songs may be randomly selected and loaded into the play list, or only the songs after ranking will be loaded into the play list.

For example, when a song A is played, and the equalizer is adjusted at the same time, the multimedia player will record parameters of the equalizer adjustment when the song A is played and store them into the play list. In addition to the equalizer, the playback mode of a song may also be key ascending/descending or volume change of the song.

When the multimedia player starts to play songs on Monday of the second week, the multimedia player will load the play list created on Monday of the first week. In order to avoid the feeling of repeated playback for user, when the play list is loaded, the present invention will select a part of the songs from the collection of songs not recorded in the play list to replace a part of the songs in the play list.

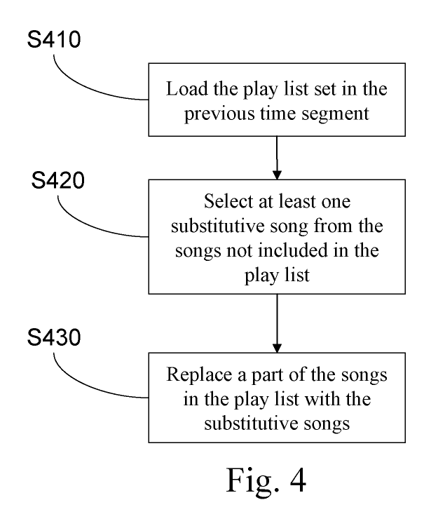

FIG. 4 is a schematic view of the operation flow of selecting substitutive songs. Referring to FIG. 4, the selecting of the substitutive songs includes the following steps. The play list set in the previous time segment is loaded (step S410). Selecting at least one substitutive song from the songs not included in the play list (step S420). A plurality of substitutive songs is randomly selected from the songs not included in the play list to replace a part of the songs in the play list. Replace a part of the songs in the play list with the substitutive songs (step S430).

For example, the play list records 100 songs. When the multimedia player loads the play list, 10 songs will be selected from the 2900 songs not included in the play list to randomly replace 10 songs in the play list. Therefore, different songs will be loaded during playback. If a substitutive song is canceled during playback, the substitutive song will be removed from the play list.

The present invention is not limited to be applied to the multimedia player with or without a display unit. Since the present invention determines the play lists according to different time segments and the playback modes of songs, play lists that accord with the users' habits can be created rapidly even in the multimedia player without a display unit.

The multimedia player of the present invention automatically records the playback modes of the songs in different time segments in a time period, and creates the play lists according to the playback modes of the songs. In the next time segment, the multimedia player will preferably select the songs in the play lists. Moreover, the present invention creates the play lists according to the number of times that the songs are completely played. Thus, the problem of editing appropriate play lists when the number of the songs is too big is solved. In addition, when the songs are played, the previous playback modes of the songs will be applied in the playback this time.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of automatic play list creation on a multimedia player, comprising:
creating a play list, counting a number of times that each song is completely played in a time segment of a time period, and writing names of the songs into the play list belong to the time segment, such that the multimedia player loads the play list in a same time segment of another time period, and plays the songs in the play list;
recording a playback mode of a song, and recording playback modes set for the songs in the play list during playback; and
storing the play list corresponding to the time segment.

2. The method of automatic play list creation on a multimedia player as claimed in claim 1, wherein the multimedia player is a MP3 player, a CD-ROM player, or a MD player.

3. The method of automatic play list creation on a multimedia player as claimed in claim 1, wherein the time period is a year, a quarter of a year, a month, a week, or a day.

4. The method of automatic play list creation on a multimedia player as claimed in claim 3, wherein the time segment is a quarter of a year, a month, a week, a day, a forenoon, a noon, an afternoon, an evening, a night, or a morning.

5. The method of automatic play list creation on a multimedia player as claimed in claim 1, wherein setting the play list comprises selecting the songs that are completely played for the number of times meeting a threshold value and adding the songs into the play list.

6. The method of automatic play list creation on a multimedia player as claimed in claim 1, wherein recording the playback mode set for the song during playback comprises recording a volume change of the song.

7. The method of automatic play list creation on a multimedia player as claimed in claim 1, wherein recording the playback mode set for the song during playback comprises recording an equalizer setting of the song.

8. The method of automatic play list creation on a multimedia player as claimed in claim 1, wherein recording the playback mode set for the song during playback comprises recording a key ascending/descending value of the song.

9. The method of automatic play list creation on a multimedia player as claimed in claim 1, wherein playing the songs in the play list further comprises:
loading the play list set in previous the time segment;
selecting at least one substitutive song from among the songs not in the play list; and
replacing a part of the songs in the play list with the substitutive songs.

10. The method of automatic play list creation on a multimedia player as claimed in claim 9, wherein a plurality of substitutive songs is randomly selected from among the songs not in the play list, and a part of the songs in the play list are replaced by the substitutive songs.

11. The method of automatic play list creation on a multimedia player as claimed in claim 1, wherein loading the play list further comprises:
when the currently played play list is canceled for a number of times reaching a switching threshold value, randomly selecting a play list of another time segment, and loading the selected play list into the multimedia player for playback.

12. The method of automatic play list creation on a multimedia player as claimed in claim 11, wherein the switching threshold value is determined according to a proportion of the songs in the play list.

13. A multimedia play capable of automatically creating a play list, wherein the multimedia play stores a plurality of play lists, the multimedia player comprising:
a playback module, for decoding songs to play, and providing a playback function of the songs;
a storage unit, electrically connected to the playback module, for storing a plurality of songs;
a selecting means, for automatically generating a play list, and recording the songs that are played for a number of times meeting a threshold value in a time segment into the play list corresponding to the time segment; and
a database module, for storing the play list.

14. The multimedia play capable of automatically creating a play list as claimed in claim 13, wherein the multimedia player is a MP3 player, a CD-ROM player, or a MD player.

15. The multimedia play capable of automatically creating a play list as claimed in claim 13, wherein the selecting means is further used to record a playback mode set for each of the songs during playback in the time segment.

16. The multimedia play capable of automatically creating a play list as claimed in claim 15, wherein the playback mode set for each of the songs during playback in the time segment is one selected from among a playback time of the currently playing song, a volume change of the currently playing song, a equalizer setting of the currently playing song, and a key ascending/descending value of the currently playing song.
